(19) United States
(12) Patent Application Publication
(10) Pub. No.: US 2001/0017867 A1
(43) Pub. Date: Aug. 30, 2001

(54) Fiber amplifier

(75) Inventors: Juergen Kraenert, Jena (DE); Thomas Gabler, Kromsdorf (DE); Holger Zellmer, Magdala (DE); Andreas Tuennermann, Jena (DE)

Correspondence Address: Gerald H. Kiel, Esq., REED SMITH LLP, 375 Park Avenue, New York, NY, 10016-2391, US

(73) Assignee: SCHNEIDER Laser Technologies AG

(21) Appl. No.: 09/794,861

(22) Filed: Feb. 27, 2001

(30) Foreign Application Priority Data
Feb. 29, 2000 (DE) 100 09 380.9

(51) Int. Cl. H01S 3/00

(52) U.S. Cl. 372/6; 359/341.1

(57) ABSTRACT

A fiber amplifier is disclosed comprising a signal source (oscillator), an amplifier fiber and a pump laser. The amplifier fiber is arranged between two polarizers and a portion of the beam that is depolarized in the amplifier fiber is coupled out at the amplifier output, returned to the amplifier input, coupled into the amplifier fiber with the radiation from the signal source and amplified again, and another portion, as linearly polarized beam, exits the fiber amplifier as useful beam.

### BACKGROUND OF THE INVENTION

a) Field of the Invention

The invention is directed to a fiber amplifier, in particular, a fiber amplifier comprising a signal source (oscillator), an amplifier fiber and a pump laser.

b) Description of the Related Art

With respect to power parameters, fiber lasers and fiber amplifiers have been scaled at extremely high laser outputs. The principle advantages are the high basic model power of greater than 100 W (CLEO 1999, V. Dominic, St. MacCormack et al. “110 W Fiber Laser”) with an efficiency of more than 50%. The fiber need not be cooled by water because of its large surface. These characteristics open up a wide field of novel applications, e.g., in material processing and in the printing industry.

The previous solutions are disadvantageous in that these lasers or amplifiers in most cases operate in continuous-wave mode and emit nonpolarized light (WO 97/12429). Further, the light can be partially polarized. However, it has been shown that the direction of polarization can also change spontaneously. This is brought about, e.g., by the change in the pump output and environmental conditions. Likewise, it is very difficult to amplify short pulses (100 fs to 50 ps) with high peak powers without spectral and temporal deformation. Nonlinear effects such as self-phase modulation and stimulated Raman scattering occur because of the long fiber length.

Fiber laser amplifiers for high peak powers have been described, e.g., in U.S. Pat. No. 5,867,305. The aim in this case is to achieve saturation of amplification and to prevent unwanted scatter effects. The amplification level is synchronized with the pulse repetition frequency for this purpose.

### OBJECT AND SUMMARY OF THE INVENTION

It is the primary object of the invention to provide an arrangement which delivers a high output power of laser light with a predetermined polarization direction and with the best possible beam characteristics, e.g., divergence and noise, with comparatively low expenditure.

This object is met in accordance with the invention in that a fiber amplifier comprises a signal source, an amplifier fiber and a pump laser. The amplifier fiber is arranged between two polarizers and a portion of the beam that is depolarized in the amplifier is coupled out at the amplifier output, returned to the amplifier input, coupled into the amplifier fiber with the radiation from the signal source and amplified again. Another portion, as a linearly polarized beam, exits the fiber amplifier as a useful beam.

According to the invention, a portion of the laser light which is amplified in the fiber laser and which is not polarized in the predefined direction is guided back to the amplifier input and fed into the amplification process again. The other portion of the amplified laser light with the linear polarization direction is supplied for use.

The arrangement according to the invention proposes a fiber laser amplifier in which a fixed position of the polarization direction is achieved. This amplifier is constructed as a regenerative (ring) amplifier and allows the use of short fiber lengths as amplifier medium. This arrangement is therefore particularly suited to amplification of short pulses with high power. With short fiber lengths, the effect of the nonlinear characteristics of such fibers is slight (temporal and spectral pulse deformation). Typically, fiber lengths are in the range of less than 10 m, usually from 2 m to 5 m.

The fiber amplifier is described in the following with reference to the Figures.

### BRIEF DESCRIPTION OF THE DRAWINGS

In the drawings:

FIG. 1 shows the basic principle of the arrangement for a fiber laser with optical feedback by means of polarization splitting;

FIG. 2 shows control of the optical feedback with partial polarization of the amplified laser beam; and

FIG. 3 shows mixing of the polarization directions for purposes of amplification and reduction of unwanted polarization states.

### DESCRIPTION OF THE PREFERRED EMBODIMENTS

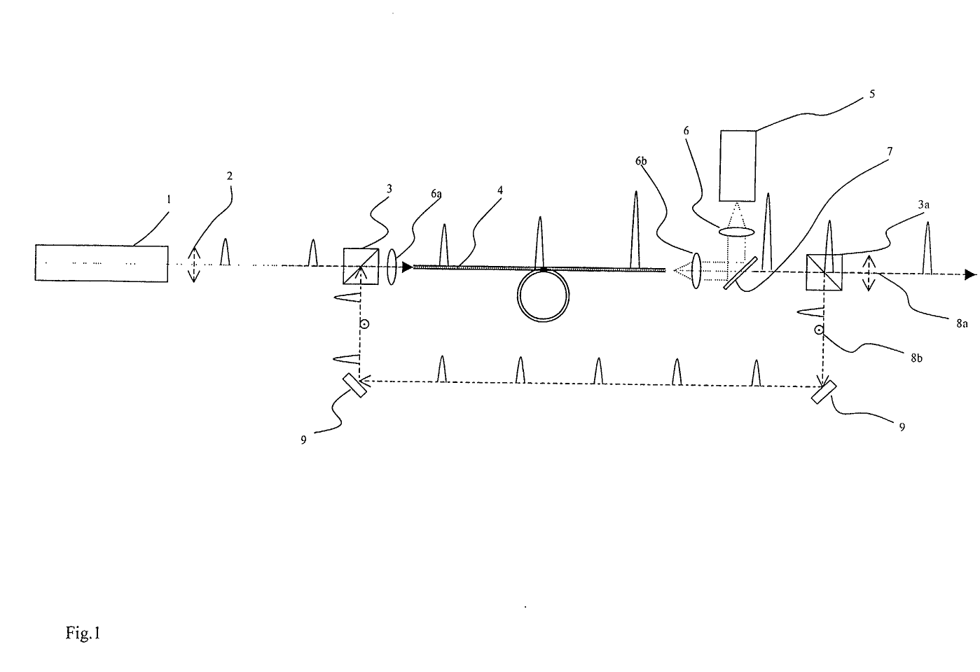

The principle of the arrangement is described with reference to FIG. 1. A C-W mode-locked oscillator 1 supplies a laser beam with short pulses (e.g., 7 ps), high repetition rate and linear polarization 2 in vertical direction. The laser beam 2 is coupled into the fiber amplifier by a polarizer 3 and lens 6a. The polarizer can be, e.g., a Glan-Thompson polarizer or dielectric thin-film polarizer. It is adjusted in such a way that the vertical (or desired) polarization direction of the oscillator 1 is transmitted without losses and can be coupled into the fiber amplifier 4 by means of the lens 6a. The fiber amplifier 4 contains a double-core fiber [2], wherein the outer core serves as pump core and the pump light of the laser diode 5 is guided along the entire length of the fiber and is coupled into the inner core at the same time. The amplification of the laser pulses of the oscillator 1 takes place in the inner core. Because of stress birefringence, the linearly polarized beam is disturbed with respect to its degree of polarization in the inner fiber core. A portion of the laser light is accordingly rotated in different polarization directions. This proportion can be influenced by the position of the fiber 4, the intensity of the pump radiation 5, the temperature and, naturally, the characteristics and construction of the double-core fiber.

The pump light from the pump laser 5 is coupled into the double-core via lenses 6 and 6b. The lens 6b serves at the same time to collimate the amplified laser radiation and is antireflection-coated dichroically for the pump wavelength and the amplified laser wavelength. The deflecting mirror 7 is highly reflecting for the pump wavelength and highly transmitting for the amplified laser wavelength and influences the polarization not at all or only minimally.

The amplified and partially depolarized light from the fiber 4 is then split by means of a second polarizer 3a into two beams 8a and 8b which are polarized perpendicular to one another. Beam 8a is the useful beam and is linearly polarized. The position of the polarization plane is given by the polarizer 3a.

The beam 8b is guided back to the amplifier again via the deflecting mirror 9 and the polarizer 3 and is coupled into the amplifier. This beam is amplified again in the amplifier and its polarization direction is partially rotated and the beam is accordingly supplied to the useful beam 8a.

In this construction (FIG. 1), the partial guiding back of the beam 8b and conversion to the useful beam 8a is controlled exclusively by means of the polarizing characteristics of the fiber 4.

The proportion of the beam 8b can be influenced with respect to its intensity by stress birefringence in the fiber. Thus, a regulating mechanism which makes it possible to optimize the power of the linearly polarized useful beam 8a is formed in interaction with the returned component of the beam.

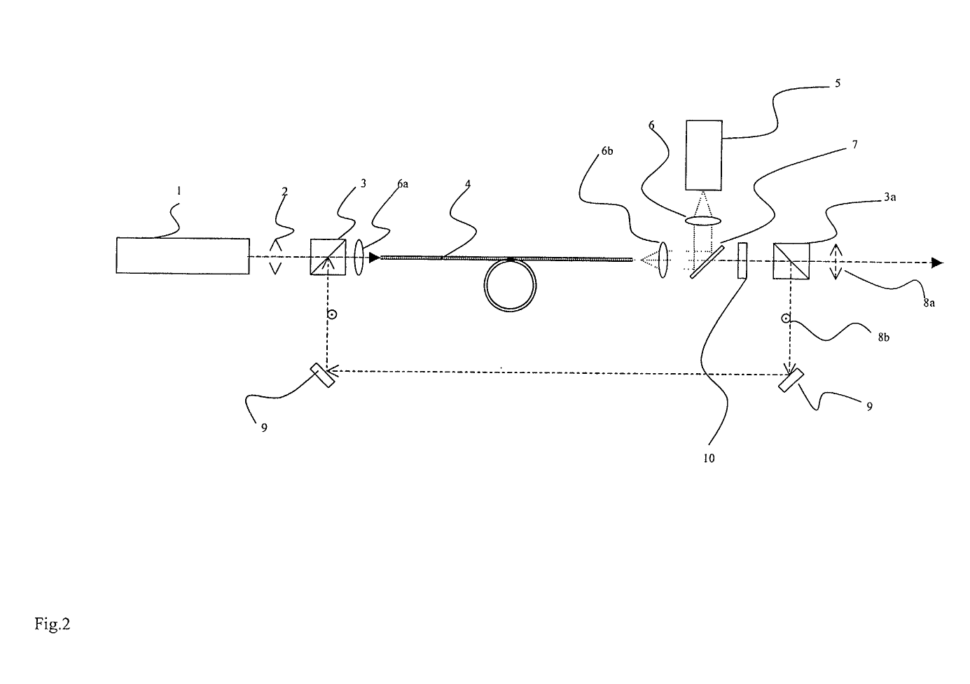

In FIG. 2, a half-wave plate 10 for the laser wavelength of the amplifier is introduced additionally in front of the polarizer. By rotating this half-wave plate, the proportion of the beam 8b can be influenced in intensity when the beam is partially polarized after amplification, i.e., the beam in front of the half-wave plate.

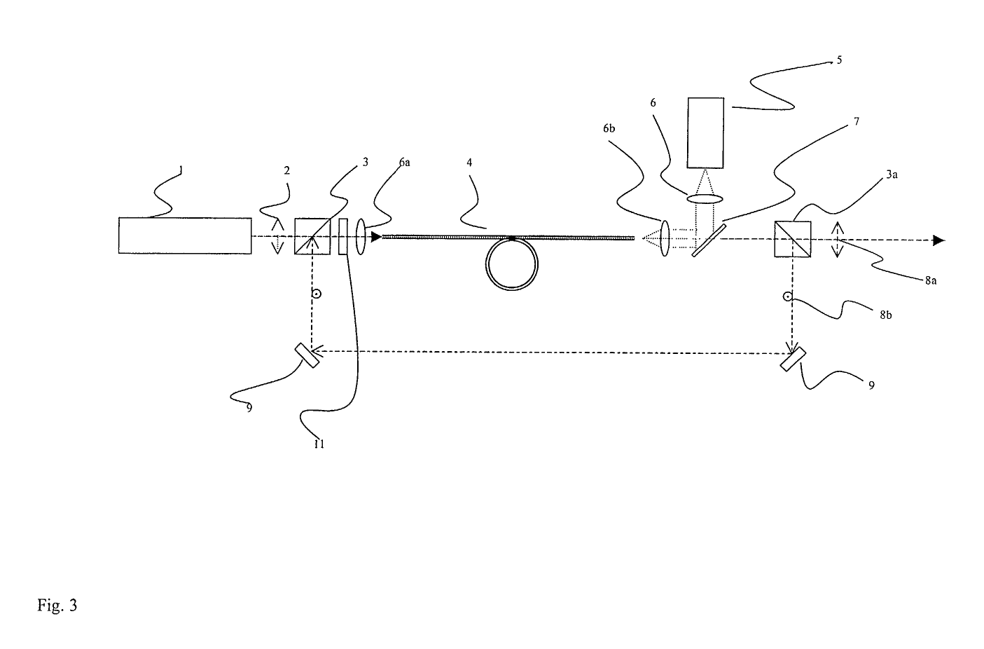

In another construction which is shown in FIG. 3, the laser beam 2 is circularly polarized by means of a quarter-wave plate 11 before coupling into the fiber amplifier. As a result of the amplification of the circularly polarized laser beam, there is no privileged direction for the polarization at the fiber output of the amplifier. The two beams 8a and 8b are then accordingly split into virtually identical components and returned to the amplifier by approximately 50%.

In order to achieve a sufficient saturation in amplification, the doping with the laser material, the fiber length, the pump output on the amplifier wavelength as well as on the pump wavelength and the feedback rate are optimized primarily. In optimizing, the shortest possible fiber length is aimed for in order to minimize nonlinear effects such as self-phase modulation and stimulated Raman scattering. This is achieved by the regenerative character of this amplifier arrangement.

This suggested solution is particularly relevant for the amplification of short pulses (100 fs - 100 ps). Two operating modes can be made possible during amplification.

The returned pulse in beam 8b can be exactly superimposed with respect to time with an arriving pulse of the oscillator in the polarizer 3, i.e., the amplifier runs synchronously. The temporal superposition is achieved by matching the optical path lengths in the amplifier branch with the optical path length for the beam 8b.

In the second operating mode, amplification is carried out asynchronously. In so doing, the pulse repetition frequency is increased because the returned pulse in the beam 8b is not superimposed with the pulse of the oscillator. The peak power remains lower, but the average power in the beam 8a accordingly increases.

While the foregoing description and drawings represent the present invention, it will be obvious to those skilled in the art that various changes may be made therein without departing from the true spirit and scope of the present.

What is claimed is:

1. A fiber amplifier comprising:
a signal source;
an amplifier fiber; and
a pump laser;
said amplifier fiber being arranged between two polarizers; and
a portion of the beam that is depolarized in the amplifier fiber being coupled out at the amplifier output, returned to the amplifier input, coupled into the amplifier fiber with the radiation from the signal source and amplified again; and
another portion, as a linearly polarized beam, exiting the fiber amplifier as a useful beam.

2. The fiber amplifier according to claim 1, wherein the depolarized beam is coupled out at the amplifier output through an analyzer and is coupled into the fiber through a polarizer at the amplifier input.

3. The fiber amplifier according to claim 1, wherein the proportion of the returned intensity at the amplifier output is adjusted by the position of the fiber, stress birefringence and pump power of the wavelength exciting the fiber amplifier.

4. The fiber amplifier according to claim 3, wherein the proportion of the returned intensity with partial polarization at the amplifier output is adjusted by a half-wave plate for the laser wavelength.

5. The fiber amplifier according to claim 3, wherein a quarter-wave plate for the laser wavelength is present at the input of the amplifier and is accordingly amplified virtually independent of polarization, and the useful beam and the returned beam split into identical proportions of intensity.

6. The fiber amplifier according to claim 1, wherein amplification is carried out synchronously or asynchronously in pulse operation or CW operation is carried out.

7. The fiber amplifier according to claim 1, wherein the length of the fiber is short enough that nonlinear processes do not appear, wherein the criterion for the respective length is that amplifier saturation is reached.
